(19) United States
(12) Patent Application Publication
(10) Pub. No.: US 2006/0206498 A1
(43) Pub. Date: Sep. 14, 2006

(54) Document information management apparatus, document information management method, and document information management program

(75) Inventor: Akihiko Fujiwara, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/076,155

(22) Filed: Mar. 10, 2005

(51) Int. Cl. G06F 17/00

(52) U.S. Cl. 707/100; 715/513

(57) ABSTRACT

A document information management program and the like is provided which can manage documents by using their metadata without increasing their file sizes. The document information management program according to the present invention is a document information management program which serves to make a computer perform document information management that manages metadata described in the inside of a document instance thereby to manage document information, and which makes a computer to execute a metadata analysis step of analyzing and acquiring the metadata described in the inside of the document instance, a storage operation sep of storing a prescribed piece of metadata among the metadata analyzed in said metadata analysis step into a storage device in such a manner as to be able to make it correspond to the document, and a metadata deletion operation step of deleting the metadata stored in said storage device from the inside of said document instance.

### BACKGROUND OF THE INVENTION

1. Field of the Invention

The present invention relates to a document information management apparatus, a document information management method, and a document information management program for managing the metadata of documents to perform document management.

The terms used in this specification will be described herein below.

An “original document” means a document of a paper medium obtained by printing a document on paper.

The “instance of a document” means an actual entity that depend on the style or format by which the document is described, and for example, in a Windows file system, it is a file that is managed thereon, and in a document management system, it is a data record or the like that is stored in a database managing images thereon. As styles or formats, there are TIFF, PDF, storage forms specific to document management systems, and so on.

The “metadata of a document” includes attribute and/or property information such as the creator of the document, the group to which the creator belongs, the place in which the creator is mainly resident, users of the document, the group or groups to which the users belong, the place or places in which the users are mainly resident, the date and time of creation, the weather at the time of creation, the environment around the creator at the time of creation, the dates and times of use, the weathers at the times of use, the environments around the users, the application used for creation, etc.

A “document information processing apparatus” means an apparatus that processes, registers and manages the above document and its metadata. Information on documents to be managed includes location information on the documents existing on a system (which, for example in an explore, a file viewer, of a Microsoft Windows, is managed as paths in a folder structure that depends on a Windows file system), links (for example, links to respective application forms displayed on the top pages of enterprise portals), layout or placement structures according to contents (for example, categories of Yahoo), and so on. Also, this apparatus can further contains systems that provide management structures to keep or store documents themselves (for example, document management systems). The apparatus is available from a plurality of users and has a user authentication function and a common function to be shared through networks. In addition, the apparatus is able to cooperate with various devices of the above-mentioned document input/output system so as to extend its function so as to perform media conversion between paper data and electronic data as well as an external communication facility such as facsimile.

A “document input/output system” means a system which has such a device as a printing device (printer), an image reader (scanner), an image communication device (fax), or the like, and which can handle documents and original documents. A document information management apparatus according to the present invention is provided for this document input/output system. Here, note that the document information management apparatus can be arranged inside the document input/output system or outside thereof separately and independently, and in addition, such a single apparatus can be arranged in common for a plurality of document input/output systems.

A “module” means a software module that is possessed by each of the component devices of the document information processing apparatus or the components of the document input/output system.

An “operation history” means some operations (e.g., opening, saving, printing, e-mailing of the document, et.) which were made to a document by applications or a system and recorded as history.

A “history management system” means a system that extracts information related to a document and/or its attributes (document related information and/or attribute related information) by collecting and analyzing the operation history, and manages them with the document.

“Information associated with a document/document related information” means operation history information obtained by collecting operations on a document or information obtained through analysis based on a history information and the like (reference and/or derived documents, etc.).

“Information associated with attributes/attribute related information” means relevant information extracted from metadata in the operation history information obtained by collecting operations on a document, or attribute related information extracted from the document related information, and is a synonym of a secondary metadata.

2. Description of the Related Art

A conventionally known document input/output system has a document information management apparatus in which when a document is managed, metadata possessed by the document is also managed at the same time. For example, when a scanned image document is created by scanning a document, information such as the name of a user who carried out the scanning, the date and time of the scanning, etc., is managed together with the document while being associated therewith. For example, in the conventional document information processing apparatus and the document input/output system, in case where metadata is managed while being described in a document instance (e.g., when a scanned image is saved as a PDF file that is created by pasting the scanned image to an entire page as an image, the metadata is described by using a description area of attribute data specified by a PDF file format), there is adopted a technique of collecting metadata in response to operation timing such as inputting/outputting, editing, etc., of a document, and describing it in the document instance. In addition, as the kind of the metadata, secondary metadata is extracted by analyzing the collected metadata, or metadata in continuous operations on a document is collected as a history in a multistage manner, or metadata of each of the component parts (an image area, a character area, etc.) of contents of a document is collected in accordance with the property of the component parts. The convenience in doing a search or classification has been enhanced by handing a multitude of pieces of metadata. In this connection, note that Japanese patent application laid-open No. 2003-280950 is known as a technical document related to the present invention.

In the conventional document management apparatus, however, in case of describing or writing metadata into a document instance, when many kinds of pieces of metadata or continuously collected pieces of metadata are to be written into the document instance in a multistage manner so as to increase convenience, the data size of the metadata is increased and the file size of the document instance itself is also increased accordingly. The metadata is basically described in the document instance so as to keep the portability and versatility of the document, but in contrast, the file size increased for improved convenience resulting in impairment of such portability and versatility is contrary to the intended purpose.

### SUMMARY OF THE INVENTION

The present invention is intended to obviate the problems as referred to above, and has for its object to obtain a document information management apparatus, a document information management program, and a document information management method capable of managing documents by using their metadata without increasing their file sizes.

In order to solve the above-mentioned problems, a document information management apparatus according to the present invention comprises: a metadata analysis section that analyzes and acquires metadata described in a document instance; a storage operation section that stores a prescribed piece of metadata among said metadata analyzed by said metadata analysis section into a storage device in such a manner as to be able to make it correspond to said document; and a metadata deletion operation section that deletes said metadata stored in said storage device from the inside of said document instance.

In this document information control apparatus, provision is made for an analyzed metadata presentation section that presents said metadata analyzed by said metadata analysis section to a user, wherein said storage operation section stores into said storage device those pieces of metadata, among said metadata presented by said analyzed metadata presentation section, which are instructed by said user, and said metadata deletion operation section deletes said pieces of metadata instructed by said user from the inside of said document instance.

In addition, provision is made for a use trend analysis section that analyzes the trend of the use of metadata of said user, wherein said storage operation section stores a prescribed piece of metadata based on the use trend of said user analyzed by said use trend analysis section into said storage device, and said metadata deletion operation section deletes said prescribed piece of metadata based on the use trend of said user analyzed by said use trend analysis section from the inside of said document instance.

Moreover, provision is made for a document operation condition monitoring section that monitors a document operation condition of said user, wherein said metadata analysis section analyzes and acquires metadata described in said document instance at predetermined timing based on the monitoring result of said document operation condition monitoring section.

Further, provision is made for a stored data acquisition section that acquires metadata from said storage device, and a metadata writing operation section that writes a prescribed piece of metadata among said metadata acquired by said stored data acquisition section into said document instance.

Furthermore, provision is made for an acquired metadata presentation section that presents said metadata acquired by said stored data acquisition section to said user, wherein said metadata writing operation section writes into said document substance those pieces of metadata, among said metadata presented by said acquired metadata presentation section, which are instructed by said user.

Still further, provision is made for a new metadata acquisition section that extracts new metadata from a plurality of pieces of metadata and externally managed data, and a new metadata writing operation section that writes a prescribed piece of metadata among said metadata acquired by said new metadata acquisition section into said document instance.

Besides, provision is made for a new metadata presentation section that presents said metadata acquired by said new metadata acquisition section to said user, wherein said new metadata writing operation section writes into said document substance those pieces of metadata, among said metadata presented by said new metadata presentation section, which are instructed by said user.

In addition, the present invention resides in a document information management program for making a computer execute document information management that manages metadata described in the inside of a document instance thereby to manage document information, said document information management program serving to make said computer execute: a metadata analysis step of analyzing and acquiring the metadata described in the inside of said document instance; a storage operation sep of storing a prescribed piece of metadata among said metadata analyzed in said metadata analysis step into a storage device in such a manner as to be able to make it correspond to said document; and a metadata deletion operation step of deleting said metadata stored in said storage device from the inside of said document instance.

Moreover, the present invention resides in a document information management method for managing metadata described in a document instance thereby to manage document information, said method comprising: a metadata analysis step of analyzing and acquiring the metadata described in the inside of said document instance; a storage operation sep of storing a prescribed piece of metadata among said metadata analyzed in said metadata analysis step into a storage device in such a manner as to be able to make it correspond to said document; and a metadata deletion operation step of deleting said metadata stored in said storage device from the inside of said document instance.

### DESCRIPTION OF THE DRAWINGS

FIG. 1 is an overall block diagram showing a document information management apparatus for managing metadata in an embodiment of the present invention.

FIG. 2 is a view illustrating the concept of a document in this embodiment.

FIG. 3 is a flow chart illustrating an operation of the first embodiment of the present invention.

FIG. 4 is a view showing one example of a metadata movement instruction screen in the first embodiment.

FIG. 5 is a view showing one example of a data record to an external storage area in the first embodiment.

FIG. 6 is a flow chart illustrating an operation of a second embodiment of the present invention.

FIG. 7 is a flow chart illustrating an operation of a third embodiment of the present invention.

FIG. 8 is a view showing one example of a metadata editing instruction screen in the third embodiment.

FIG. 9 is a view showing a document instance exported according to the third embodiment.

### DESCRIPTION OF THE EMBODIMENTS

Hereinafter, a preferred embodiment of the present invention will be described in detail while referring to the accompanying drawings.

Here, note that in the following description, it is assumed that XX in [XX] represents the name of metadata, and XX in “XX” represents the value or content of the metadata.

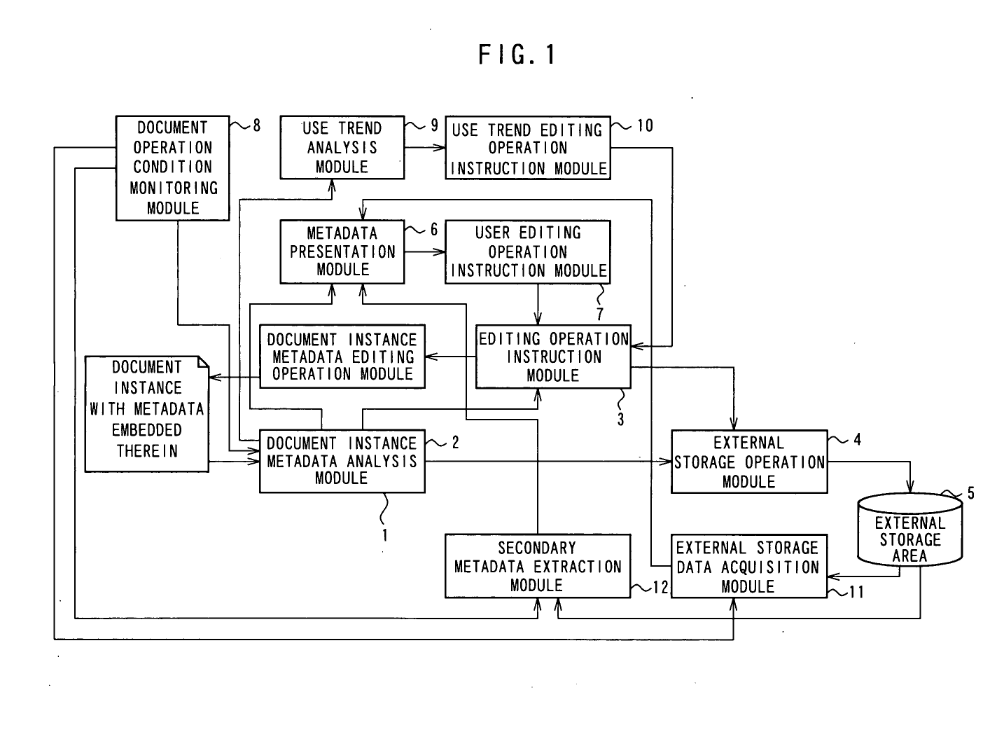

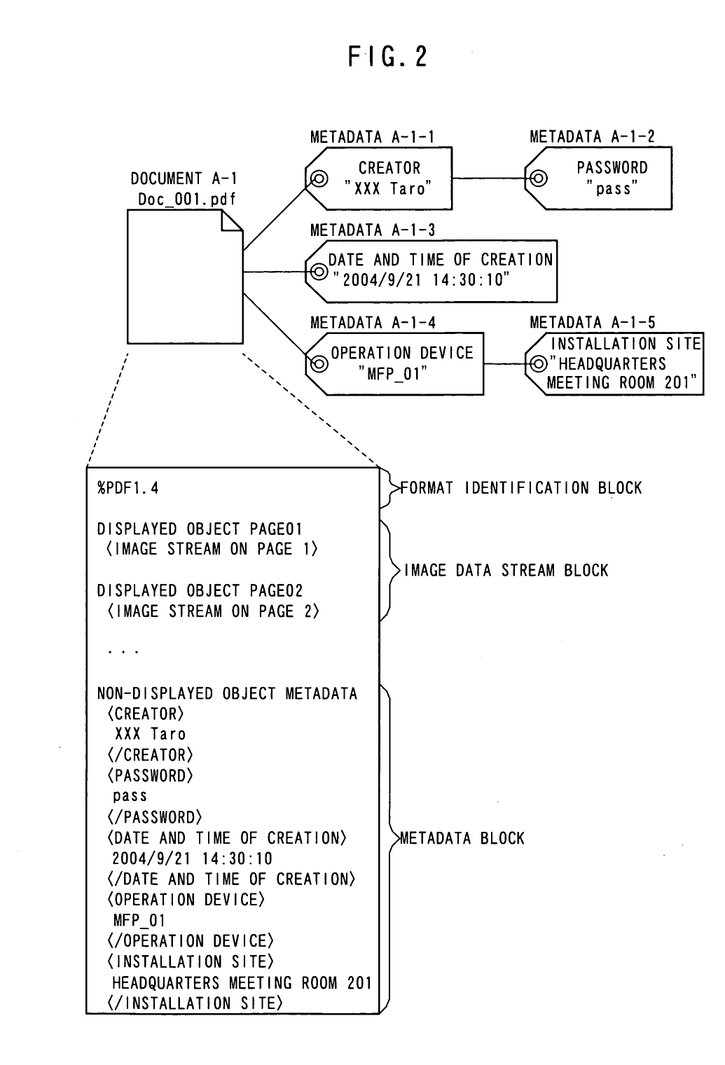

FIG. 1 is an overall block diagram that shows a document information management apparatus for managing metadata in the form of document information in the embodiment of the present invention. FIG. 2 is a view that describes the concept of a document in this embodiment.

This document information management apparatus includes a document instance metadata analysis module 1, a document instance metadata editing operation module 2, an editing operation instruction module 3, an external storage operation module 4, an external storage area 5, a metadata presentation module 6, a user editing operation instruction module 7, and a document operation condition monitoring module 8.

Further, the document information management apparatus includes a use trend analysis module 9, a use trend editing operation module 10, a secondary metadata extraction module 11, and an external storage data acquisition module 12.

The document instance metadata analysis module 1 is a software module that analyzes the contents of metadata blocks described in the document instance of a document such as document A-1 in FIG. 2.

The document instance metadata editing operation module 2 is a software module that edits the contents of the metadata blocks described in the document instance of a document such as document A-1 in FIG. 2.

The editing operation instruction module 3 is a software module that instructs the contents of editing to the document instance metadata editing operation module 2.

The external storage operation module 4 is a software module that stores the metadata analyzed by the document instance metadata analysis module 1 in the external storage area 5 such as a database system.

The external storage area 5 is a region for storing the metadata stored by the external storage operation module 4, and it comprises, for example, a table of a relational database system, an XML record in an XML database system, a data file on a file system, etc.

The metadata presentation module 6 is a software module that presents the metadata analyzed by the document instance metadata analysis module 1 to a user, and is able to present a list of the analyzed metadata to the user, such as by constructing a screen of a graphical user interface.

The user editing operation instruction module 7 is a software module which can receive an instruction for how the user to edit the metadata described in the document substance. According to how the user edits the metadata described in the inside of the document instance, or constructs the screen of the graphical user interface, the user can instruct or designate those pieces of metadata, among the list of metadata, which should be moved to the external storage area 5 so as to be deleted or removed from the inside of the document instance.

The document operation condition monitoring module 8 is a module that monitors the condition or situation in which a document is operated in the system.

The use trend analysis module 9, being capable of giving a trigger to start the movement of metadata by monitoring a condition or situation such as the fact that a new document is stored or saved by an input device, the total size of stored documents exceeds a predetermined value, etc., is a software module that collects the situation of an instruction for the movement of the metadata given by the user through the user editing operation instruction module 7 and analyzes the tendency thereof.

The use trend editing operation module 10, which, when the the user has frequently moved a specific piece of metadata to the external storage area 5, is able to make a determination that the metadata is made an object to be moved without any instruction from the user, is a software module that can receive an instruction for how to edit the metadata described in the document instance based on the use trend of the user analyzed by the use trend analysis module 9. When a trigger for starting the movement of the metadata is given by the document operation condition monitoring module 8, it is possible to automatically perform the movement processing without obtaining a user's operation.

The external storage data acquisition module 11 is a software module that acquires the data to be described from the metadata recorded in the document instance by the external storage area 5. When a document is passed to the outside from a management domain of the system, the metadata originally described therein is described again in the document instance, or when metadata not originally provided by a pertinent document is to be newly described, data can be acquired.

The secondary metadata extraction module 12 is a software module that extracts secondary metadata by performing knowledge processing from metadata or other information recorded in the external storage area 5. It is possible to extract highly convenient secondary information from metadata on document operations recorded in the external storage area 5, schedule information separately managed or the like by using an appropriate technique such as inference, pattern matching, mining, history analysis, etc.

A document to be handled by the present invention is the one as illustrated in FIG. 2. Here, reference will be made to the case where a paper document is read by the input device (scanner, etc.) among the document information management apparatus, and is pasted onto a specific format (PDF file, etc.) as image data in the form of a page image.

When a scanned image is created as a PDF file, a block to identify the format of the file, or a block of stream data describing the input image data as PDF page data, or a block that is not displayed with a viewer such as Acrobat Reader but embedded in the file as data, or the like is described into a file instance. An image of each page of the scanned document is described in an image stream as one page of the PDF file, and such a process is repeated for the number of pages of the paper document thus scanned. These pieces of metadata thus collected are described as an XML stream for a data area which is not displayed as an image. Here, the name “XXX Taro”of the user who logged in to perform a scanning operation is assigned as a value for the [creator], and a password “pass” of the user who logged in to perform the scanning operation is assigned as a value for the [creator's password], and “2003/9/19 14:30:10”, which is the date and time at which the scanning operation was performed, is assigned as a value for the [date and time of creation]. Moreover, an identification name “MFP_{—}01”, attached to a multi-function copying machine that is provided with the input device which performed the scanning operation, is assigned as a value for the [operation device], and a “headquarters meeting room 201” is assigned as a value for the [installation site] of the device. These values of the metadata are beforehand set in an input/output (I/O) management device, so that when an operation such as scanning, etc., is performed, the management device is able to acquire the set values. Further, in case of values such as the [password] or the like important from the standpoint of security, they can be described through encryption.

### Embodiment 1

Now, a first embodiment of the present invention will be described below. This first embodiment can include, in the above-mentioned construction of FIG. 1, a document instance metadata analysis module 1, a document instance metadata editing operation module 2, an editing operation instruction module 3, an external storage operation module 4, an external storage area 5, a metadata presentation module 6, a user editing operation instruction module 7, and a document operation condition monitoring module 8.

Reference will be made, as one example of the processing performed in the first embodiment, to the processing of moving metadata A-1-4 and metadata A-1-5 among the pieces of metadata in the document distance of FIG. 2 to the external storage area 5 thereby to remove them from the document instance.

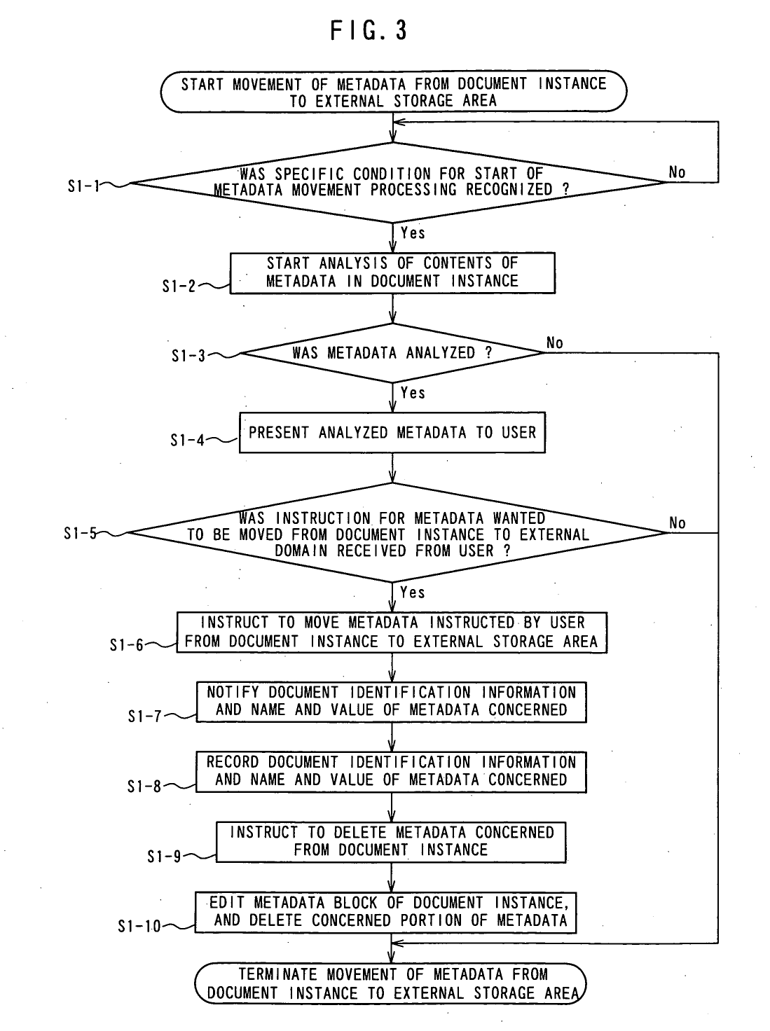

In the following, reference will be made to the operation of the first embodiment while using a flow chart illustrated in FIG. 3.

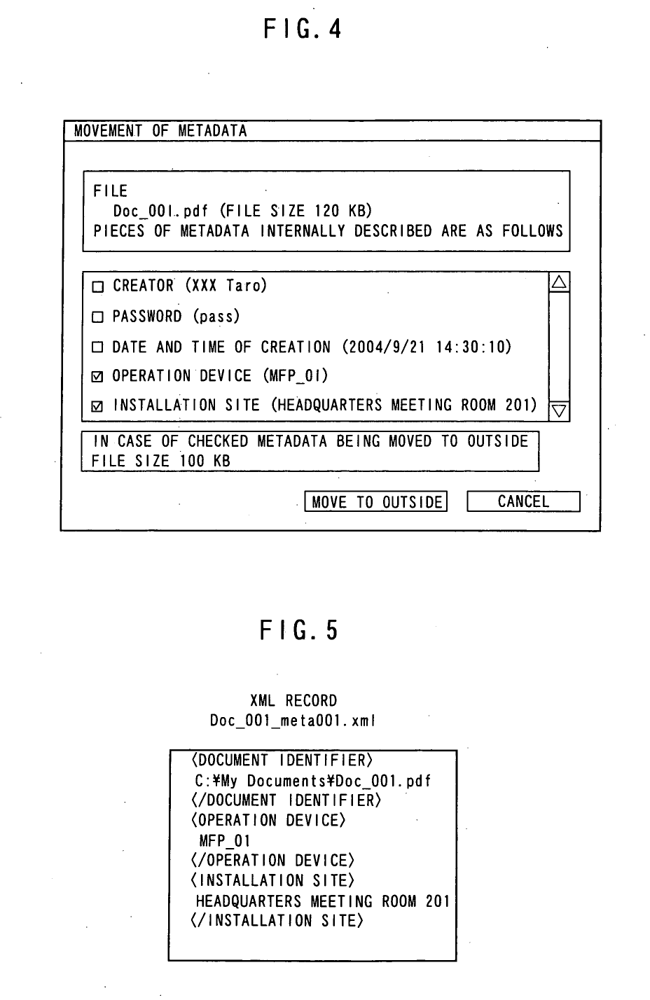

The document operation condition monitoring module 8 monitors the operational condition or situation of a document in the system, and a flow of the movement of metadata to the external storage area 5 is started by a document instance being registered into the system (S1-1). Here, reference will be made to the case where a paper document is scanned by an input device (scanner) to create a file “Doc_{—}001.pdf” of a document instance thereof having a PDF file format with its peripheral information being made as metadata, and to save or store it into an area on a file system managed by the system. When the file is saved, the document instance metadata analysis module 1 starts an analysis of the document instance file (S1-2). Here, such an analysis is carried out by reading metadata blocks in the PDF file. When the document instance metadata analysis module 1 analyzes the metadata in the “Doc_{—}001.pdf” (S1-3), the analyzed metadata is presented to the user by the metadata presentation module 6 (S1-4). Here, it is presented to the user by constructing a graphical user interface as shown in FIG. 4. The user can verify a list of metadata described in the “Doc_{—}001.pdf” by looking at a screen constructed by the metadata presentation module 6. In addition, when the user selects, from the list, a piece of metadata which is determined unnecessary to be described in the document distance, the user is able to verify the size of the document file beforehand when that piece of metadata is deleted from the document instance, so the user can obtain determination information as a result of comparison between the thus verified document file size and the present file size. This can be done by measuring the size of each piece of metadata upon analysis of the document instance metadata analysis module 1 (the values of FIG. 4 are just for reference only). When an instruction that the user wants to move a piece of metadata from the inside of the document instance to the external storage area 5 by the use of this screen is given (e.g., in FIG. 4, a “move to outside” button is clicked after the pertinent metadata has been checked), the user editing operation instruction module 7 received the instruction (S1-5). Here, let us assume that the user made an instruction to move the metadata of an “operation device” and an “installation site” to the outside without feeling the need to write the metadata into the document instance. Then, the user editing operation instruction module 7 sends the instruction for moving these pieces of metadata from the inside of the document instance to the external storage area 5 to the editing operation instruction module 3 (S1-6).

First of all, the editing operation instruction module 3 performs the processing of recording the designated metadata into the external storage area 5. To this end, the editing operation instruction module 3 notifies identification information to the external storage operation module 4 so as to be able to identify the name and values of the metadata and the originating document instance thereof (S1-7) Here, “MFP_{—}01”, “headquarters meeting room 201 “and” C:¥My Documents¥Doc_{—}001.pdf” are notified as the value of the [operation device], the value of the [installation site], and the path and file name of the file stored as document identification information, respectively. The external storage operation module 4 having received the notification records those pieces of information into the external storage area 5 (S1-8). Here, these pieces of information are saved or stored as an XML record as shown in FIG. 5 by utilizing the XML database system as the external storage area 5.

When the external recording is successful, the editing operation instruction module 3 provides an instruction for removing or deleting the pertinent metadata from the document instance to the document instance metadata editing operation module 2 (S1-9). Here, the removal or deletion of the metadata of the [operation device] and the[installation site]from the “Doc_{—}001.pdf ” is instructed. Then, the document instance metadata editing operation module 2 removes or deletes these pieces of metadata from the metadata blocks in the document instance (S1-10). This can be done by creating a metadata block not containing the pertinent metadata and replacing an existing metadata block with the thus created one thereby to reconstruct the file.

In the above-mentioned construction, the document instance metadata analysis module 1 in this embodiment corresponds to a metadata analysis section according to the present invention; the document instance metadata editing operation module 2 corresponds to a metadata deletion operation section according to the present invention; the external storage operation module 4 corresponds to a storage operation section according to the present invention; the metadata presentation module 6 corresponds to an analytical metadata presentation section according to the present invention; and the document operation condition monitoring module 8 corresponds to a document operation condition monitoring section according to the present invention.

In addition, the step S1-1 corresponds to a document operation condition monitoring step according to the present invention; the step S1-2 corresponds to a metadata analysis step according to the present invention; the step S1-8 corresponds to a storage operation step according to the present invention; the step S1-10 corresponds to a metadata deletion operation step according to the present invention: and the step S1-4 corresponds to an analytical metadata presentation step according to the present invention.

### Embodiment 2

In a second embodiment of the present invention, provision is further made for a use trend analysis module 9 and a use trend editing operation instruction module 10 in addition to the construction of the first embodiment.

Reference will be made, as one example of processing performed by these modules, to the processing where the tendency that the user always moves the metadata of the [operation device] and the [installation site] to the external storage area 5 is obtained by an analysis of the use trend analysis module 9, and metadata A-1-4 and metadata A-1-5 among the pieces of metadata in the document distance of FIG. 2 are moved to an external storage area thereby to remove or delete them from the document instance.

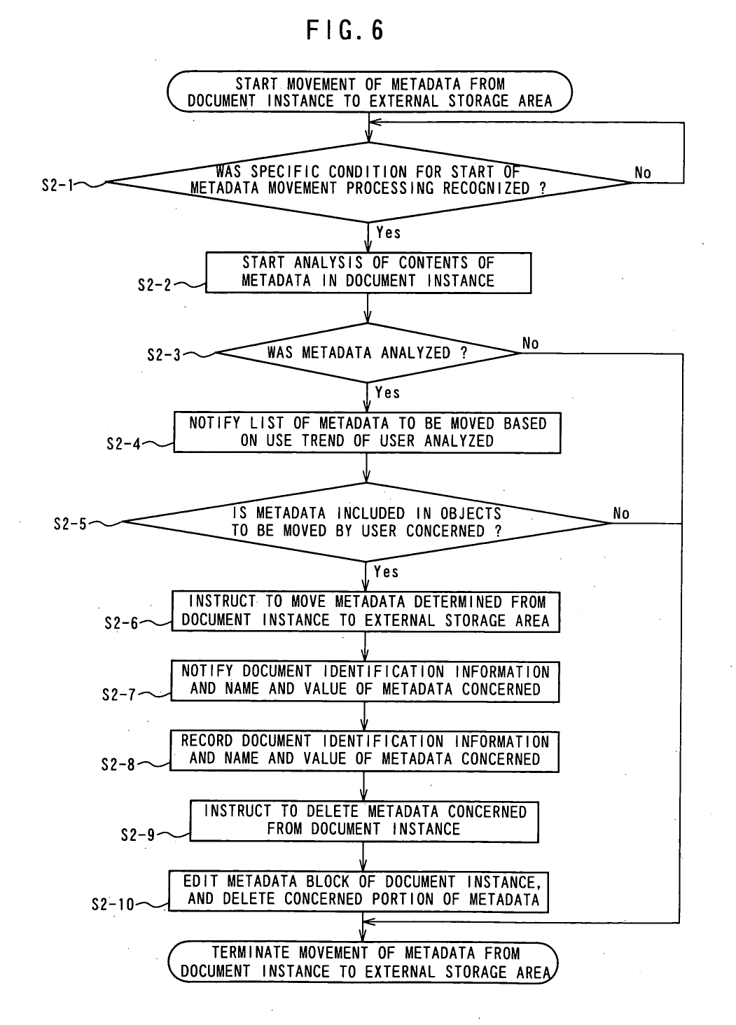

In the following, reference will be made to the operation of the second embodiment of the present invention while using a flow chart illustrated in FIG. 6.

The document operation condition monitoring module 8 monitors the operational condition or situation of a document in the system, and a flow of the movement of metadata to the external storage area 5 is started by a document instance being registered into the system (S2-1). Here, reference will be made to the case where a paper document is scanned by an input device (scanner) to create a file “Doc_{—}002.pdf” of a document instance thereof having a PDF file format with its peripheral information being made as metadata, and to save or store it into an area on a file system managed by the system. When the file is saved, the document instance metadata analysis module 1 starts an analysis of the document instance file (S2-2). Here, such an analysis is carried out by reading metadata blocks in the PDF file. When the document instance metadata analysis module 1 analyzes metadata in the “Doc_{—}002.pdf” (S2-3), a list of pieces of metadata, which was obtained from the metadata analyzed by the use trend analysis module 9 and which were frequently moved in the past by the user from the inside of the document instance to the external storage area 5, is notified to the use trend editing operation instruction module 10 (S2-4). Here, reference will be made to the case where “XXX Taro”, the user using the system, always performed the operation of moving metadata of the [operation device] and the [installation site] from the document instance to the external storage area 5 in the past. In the use trend analysis module 9, the frequency of instructions of the user “XXX Taro”to move these pieces of metadata by the use of the user editing operation instruction module 7 is counted together with the name thereof. When the rate or frequency at which the instruction for the movement was given exceeds a prescribed value, the metadata of the [operation device] and the [installation site] for the documents of the user “XXX Taro”are made objects to be moved without any specific instruction from the user, and the user name and the names of these pieces of metadata to be moved are managed in association with each other. This information is managed with the use of a table or the like of the database system. It is determined whether the analyzed metadata can match the use trend or tendency managed in this manner. It is analyzed by the document instance metadata analysis module 1 that the creator of this document is “XXX Taro”, and the use trend analysis module 9 is able to make a determination while referring to the use trend of the system user “XXX Taro” that the metadata of the [operation device] and the [installation site] are objects to be moved for the user concerned. A list of the metadata to be moved as a result of this determination is notified to the use trend editing operation instruction module 10, which then determines whether the metadata to be moved is contained in the document substance (S2-5). As a result, if the metadata to be moved is contained in the document instance concerned, the use trend editing operation instruction module 10 provides an instruction to move the metadata concerned to the editing operation instruction module 3 (S2-6) Here, it is determined from the trend or tendency of the past user's instructions that the metadata of the [operation device] and the [installation site] should not be described in the document instance, and hence an instruction to move these pieces of metadata to the external storage area 5 is made.

First of all, the editing operation instruction module 3 performs the processing of recording the designated metadata into the external storage area 5. To this end, the editing operation instruction module 3 notifies document identification information to the external storage operation module 4 so as to be able to identify the names and values of the metadata concerned and the originating document instance thereof (S2-7). Here, “MFP_{—}01”, “headquarters meeting room 201” and “C:¥My Documents¥Doc_{—}002.pdf” are notified as the value of the [operation device], the value of the [installation site], and the path and file name of the file stored as document identification information, respectively. The external storage operation module 4 having received the notification records those pieces of information into the external storage area 5 (S2-8).

When the recording into the external storage area 5 is successful, the editing operation instruction module 3 provides an instruction for removing or deleting the pertinent metadata from the document instance to the document instance metadata editing operation module 2 (S2-9). Here, the removal or deletion of the metadata of the [operation device] and the [installation site] from the “Doc_{—}002.pdf” is instructed. Then, the document instance metadata editing operation module 2 removes or deletes these pieces of metadata from the metadata blocks in the document instance (S2-10). This can be done by creating a metadata block not containing the pertinent metadata and replacing an existing metadata block with the thus created one thereby to reconstruct the file.

In the above-mentioned construction, the use trend analysis module 9 in this embodiment corresponds to a use trend analysis section according to the present invention.

In addition, the step S2-1 corresponds to a document operation condition monitoring step according to the present invention; the step S2-2 corresponds to a metadata analysis step according to the present invention; the step S2-4 corresponds to a use trend analysis step according to the present invention; the step S2-8 corresponds to a storage operation step according to the present invention; and the step S2-10 corresponds to a metadata deletion operation step according to the present invention.

### Embodiment 3

In a third embodiment of the present invention, provision is further made for an external storage data acquisition module 11 and a secondary metadata extraction module 12 in addition to the construction of the second embodiment.

Reference will be made, as one example of processing performed by these modules, to the editing processing where the metadata of the [operation device] and the [installation site], which were removed or deleted from the “Doc_{—}001.pdf” according to the first embodiment, are written again into the document instance thereof, and pertinent meeting information is extracted as secondary metadata based on these pieces of metadata and externally managed schedule information, and is then written into the document instance.

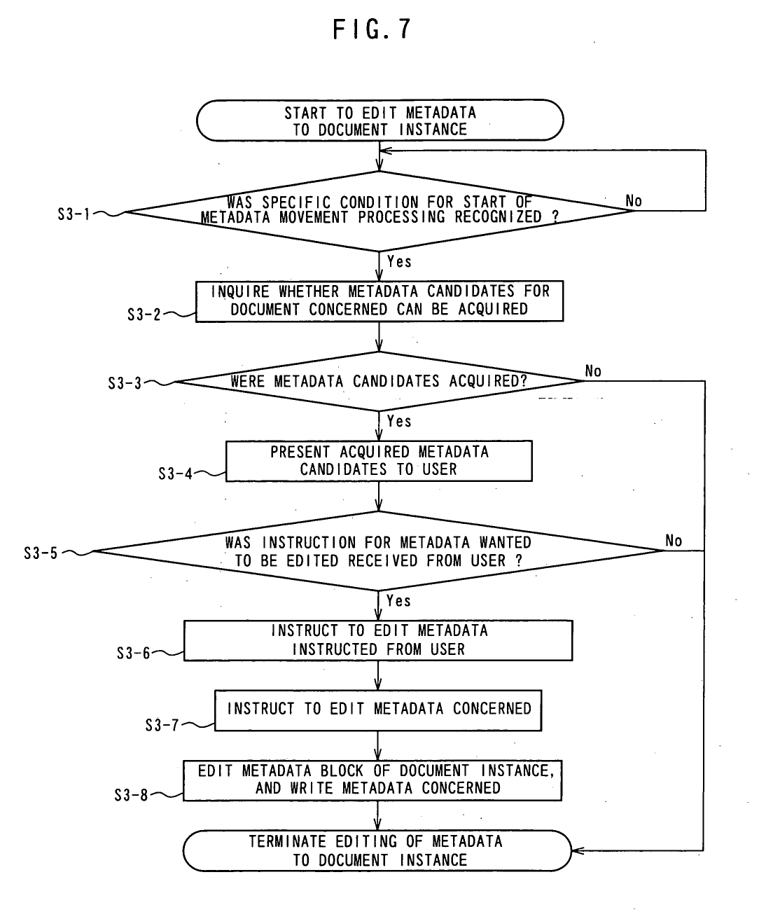

Hereinbelow, reference will be made to the operation of the third embodiment of the present invention while using a flow chart shown in FIG. 7.

The document operation condition monitoring module 8 monitors the operational condition or situation of a document in the system, and a flow of the processing of editing the metadata of the document instance thereof is started by performing the operation of exporting the document instance from the system (S3-1). Here, reference will be made to the case where the system user exports the document instance so as to take it out from the system in order to intend to pass the already registered file “Doc_{—}001.pdf” from the domain managed by the system to the outside. When the document instance is passed to the outside from the system domain in this manner, someone at a destination to which the document instance is passed sometimes wants to enhance the convenience of search, classification, etc., by utilizing the already acquired metadata. However, in the outside of the system domain, it might become impossible or invalid to make reference to the identification information or the like of a document managed in the external storage area 5. For example, a path name “C:¥My Documents¥Doc_{—}001.pdf” in the local file system of a personal computer A might not be saved or stored with the same path name if moved to and circulated in another personal computer B, so the file could not necessarily be recognized as the same one. In addition, if the external storage area 5 is opened to the public only on a local disk of the personal computer A, it will ever become impossible to access to the external storage area 5 from the personal computer B. In that case, if all the pieces of metadata are described in the document instance, there will be no need to refer to the external storage area 5 by making use of the document identification information. Accordingly, when this file “Doc_{—}001.pdf” is exported for circulation in the outside, it becomes possible to make use of the [operation device] and the [installation site] of the metadata, which were moved to be removed or deleted from the inside of the document instance upon new registration and saving of the document concerned into the system, at the destination for circulation, too, by writing again these pieces of metadata into the document instance.

When the situation or condition in which it is necessary to edit the metadata into the document instance is recognized by the document operation condition monitoring module 8, the document operation condition monitoring module 8 makes an inquiry to the external storage data acquisition module 11 and the secondary metadata extraction module 12 about whether metadata candidates for the document concerned can be acquired from the external storage area 5 (S3-2). Here, the fact that the value of the [operation device] is “MFP_{—}01” for “Doc_{—}001.pdf”, and that the value of the [installation site] is “headquarters meeting room 201” has already been registered, so the external storage data acquisition module 11 can acquire, as candidates, these pieces of metadata from the external storage area 5. Further, when the schedule information of the system user is managed by the secondary metadata extraction module 12, it is possible for the secondary metadata extraction module 12 to freshly acquire the [relevant meeting names] as secondary metadata by making inference from those pieces of information. This will be explained while referring to the case where the schedule of the meeting is registered, for instance, as the schedule information of “XXX Taro”. The “XXX Taro”registers, as schedule information, a meeting schedule in the form of a “patent review meeting” at a “headquarters meeting room 201” at a regular time every week. Then, those documents which were input by a machine “MFP_{—}01” whose [installation site] was the “headquarters meeting room 201” have a high probability that they are copies of what were written on a whiteboard or distributed materials used in this meeting. Here, a further accurate inference can be done by using such metadata as materials or information for inference together with the dates of creation, which is the metadata left in the document instance, or such metadata may be used together with a rule-based system that can convert it into designated information if it satisfies a specific pattern separately registered. Here, a “patent review meeting”, being a candidate for metadata, was able to be acquired as a relevant meeting name for meeting information.

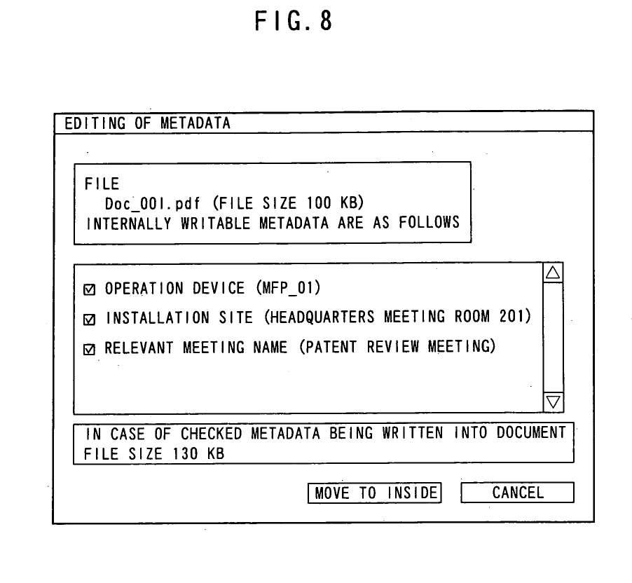

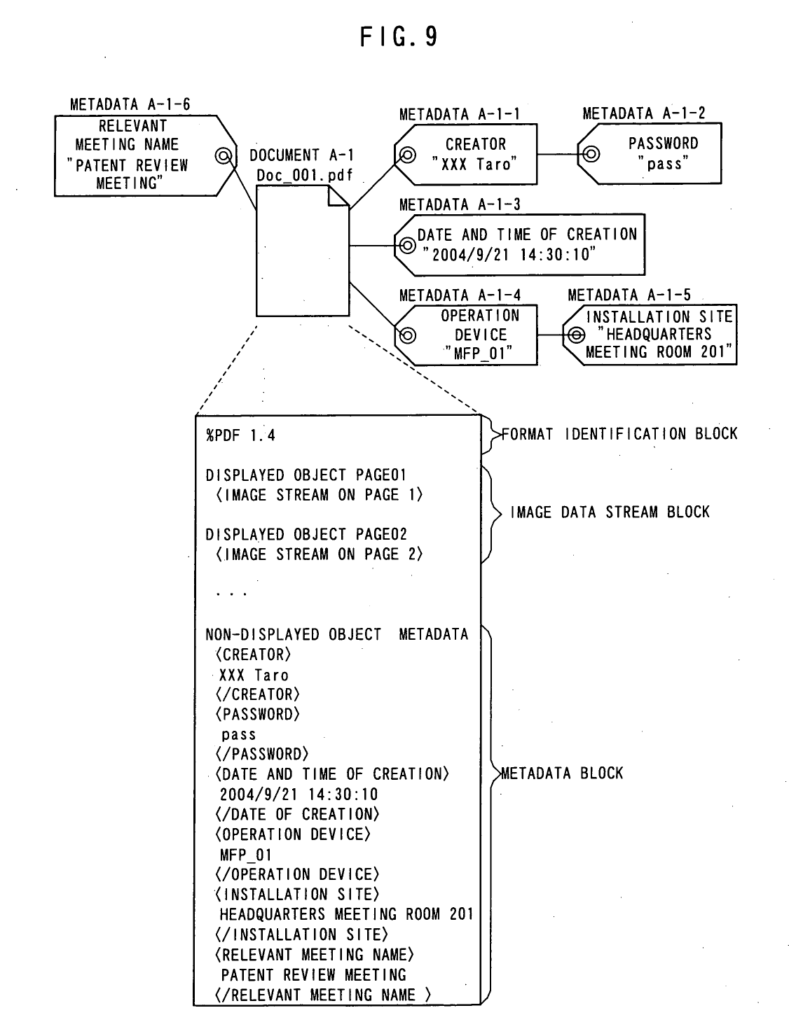

If the external storage data acquisition module 11 or the secondary metadata extraction module 12 acquires the candidate for metadata in this manner (S3-3), the metadata candidate thus acquired is presented to the user by the metadata presentation module 6 (S3-4). Here, it is presented to the user by constructing a graphical user interface as shown in FIG. 8. The user can confirm or verify a list of editable metadata in the “Doc_{—}001.pdf” by looking at a screen constructed by the metadata presentation module 6. By selecting a piece of metadata wanted to be edited from the list, the user can beforehand confirm the file size of the document instance when the metadata concerned is written into the document instance, so the user can compare it with the existing file size so as to use it as determination information. This can be done by measuring the size of each metadata candidate when the external storage data acquisition module 11 or the secondary metadata extraction module 12 acquires such metadata candidates (the values of FIG. 8 are just for reference only). When the user gives an instruction to designate a piece of metadata wanted to be edited by using this screen (e.g., in FIG. 8, the user clicks an “internal writing” button after having checked the metadata concerned), the user editing operation instruction module 7 receives the instruction (S3-5). Here, let us assume that the user instructed to return the metadata of the [operation device] and the [installation site], and to write the [relevant meeting name] of the new secondary metadata into the document instance Then, the user editing operation instruction module 7 sends an instruction for writing these pieces of metadata into the inside of the document instance to the editing operation instruction module 3 (S3-6). The editing operation instruction module 3 provides an instruction for writing the pertinent metadata into the document instance to the document instance metadata editing operation module 2 after putting it into an appropriate format (S3-7). Then, the document instance metadata editing operation module 2 writes these pieces of metadata into a metadata block in the document instance (S3-8). This can be done by creating a metadata block added by the pertinent metadata and replacing an existing metadata block with the thus created one thereby to reconstruct the file. The document instance formed in this manner is shown in FIG. 9.

Although there has been described herein an example of acquiring the metadata candidates directly associated with the document “Doc_{—}001.pdf” to be exported from the external storage data acquisition module 11 and the secondary metadata extraction module 12, such candidates may not necessarily be directly associated with the document. For example, when metadata is passed to a domain outside the system, information on the system domain originally managing the metadata may be able to be written together as metadata. This is a case where the value “headquarters laboratory domain” is written as metadata in the form of a [source or sender domain]. On the other hand, if there is metadata which is improper or inappropriate to be laid open to a domain outside the system from the standpoint of security, such metadata may be able to be edited. For example, the value of a password or the like may be set so as to be all deleted and edited, or an editing operation may be carried out so as to replace such a password with one which is safe even if opened to the public.

In the above-mentioned construction, the metadata presentation module 6 in this embodiment corresponds to an acquired metadata presentation section and a new metadata presentation section according to the present invention. Further, the external storage data acquisition module 11 corresponds to a stored data acquisition section according to the present invention, and the secondary metadata extraction module 12 corresponds to a new metadata acquisition section according to the present invention.

Moreover, the steps S3-2 and S3-3 correspond to a stored data acquisition step or a new metadata acquisition step according to the present invention, and the step S3-4 corresponds to an acquired metadata presentation step or a new metadata presentation step according to the present invention, and the step S3-8 corresponds to a metadata writing operation step according to the present invention.

In the embodiments of the present invention as referred to above, the processing operations illustrated in FIG. 3, FIG. 6, FIG. 7 and the like can be executed by a computer based on programs stored in the apparatus (document information management apparatus). However, these programs are not limited to the case where they are stored in the apparatus. That is, similar functions can be downloaded into the apparatus via a network, or a computer-readable recording medium storing therein similar functions can be installed in the apparatus. Such a recording medium can be of any form such as a CD-ROM, which is able to store programs and which is able to be read out by the apparatus. In addition, the functions to be obtained by such preinstallation or downloading can be achieved through cooperation with an OS (operating system) or the like in the interior of the apparatus.

The following advantageous effects are achieved according to the embodiments of the present invention.

(1) By extracting pieces of metadata described in the document instance and storing them externally, it is possible to reduce the file size of the document instance.

(2) By selectively extracting data according to the tendency or trend of the requests of a user, the document use of the user and so on, it is possible to make the portability and the convenience of the document instance itself compatible with each other.

(3) By selectively describing, upon circulation of the document, the metadata stored in the outside or newly added into the inside of the document instance in accordance with the trend or tendency of the user's requests and/or the user's use of the document, it is possible to enhance the versatility of the document instance.

What is claimed is:

1. A document information management apparatus comprising:
a metadata analysis section that analyzes and acquires metadata described in a document instance;
a storage operation section that stores a prescribed piece of metadata among said metadata analyzed by said metadata analysis section into a storage device in such a manner as to be able to make it correspond to said document; and
a metadata deletion operation section that deletes said metadata stored in said storage device from the inside of said document instance.

2. The document information management apparatus according to claim 1, further comprising:
an analyzed metadata presentation section that presents said metadata analyzed by said metadata analysis section to a user;
wherein said storage operation section stores into said storage device those pieces of metadata, among said metadata presented by said analyzed metadata presentation section, which are instructed by said user, and said metadata deletion operation section deletes said pieces of metadata instructed by said user from the inside of said document instance.

3. The document information management apparatus according to claim 1, further comprising:
a use trend analysis section that analyzes the trend of the use of metadata of said user;
wherein said storage operation section stores a prescribed piece of metadata based on the use trend of said user analyzed by said use trend analysis section into said storage device, and said metadata deletion operation section deletes said prescribed piece of metadata based on the use trend of said user analyzed by said use trend analysis section from the inside of said document instance.

4. The document information management apparatus according to claim 1, further comprising:
a document operation condition monitoring section that monitors a document operation condition of said user;
wherein said metadata analysis section analyzes and acquires metadata described in said document instance at predetermined timing based on the monitoring result of said document operation condition monitoring section.

5. The document information management apparatus according to claim 1, further comprising:
a stored data acquisition section that acquires metadata from said storage device; and
a metadata writing operation section that writes a prescribed piece of metadata among said metadata acquired by said stored data acquisition section into said document instance.

6. The document information management apparatus according to claim 5, further comprising:
an acquired metadata presentation section that presents said metadata acquired by said stored data acquisition section to said user;
wherein said metadata writing operation section writes into said document substance those pieces of metadata, among said metadata presented by said acquired metadata presentation section, which are instructed by said user.

7. The document information management apparatus according to claim 5, further comprising:
a new metadata acquisition section that extracts new metadata from a plurality of pieces of metadata and externally managed data; and
a new metadata writing operation section that writes a prescribed piece of metadata among said metadata acquired by said new metadata acquisition section into said document instance.

8. The document information management apparatus according to claim 7, further comprising:
a new metadata presentation section that presents said metadata acquired by said new metadata acquisition section to said user;
wherein said new metadata writing operation section writes into said document substance those pieces of metadata, among said metadata presented by said new metadata presentation section, which are instructed by said user.

9. A document information management program for making a computer execute document information management that manages metadata described in the inside of a document instance thereby to manage document information, said document information management program serving to make said computer execute:
a metadata analysis step of analyzing and acquiring the metadata described in the inside of said document instance;
a storage operation sep of storing a prescribed piece of metadata among said metadata analyzed in said metadata analysis step into a storage device in such a manner as to be able to make it correspond to said document; and
a metadata deletion operation step of deleting said metadata stored in said storage device from the inside of said document instance.

10. The document information management program according to claim 9, further comprising:
an analyzed metadata presentation step of presenting said metadata analyzed in said metadata analysis step to a user;
wherein said storage operation step stores into said storage device those pieces of metadata, among said metadata presented in said analyzed metadata presentation step, which are instructed by said user, and
said metadata deletion operation step deletes said pieces of metadata instructed by said user from the inside of said document instance.

11. The document information management program according to claim 9, further comprising:
a use trend analysis step of analyzing the trend of the use of metadata of said user;
wherein said storage operation step stores a prescribed piece of metadata based on the use trend of said user analyzed in said use trend analysis step into said storage device, and said metadata deletion operation step deletes said prescribed piece of metadata based on the use trend of said user analyzed in said use trend analysis step from the inside of said document instance.

12. The document information management program according to claim 9, further comprising:
a document operation condition monitoring step of monitoring a document operation condition of said user;
wherein said metadata analysis step analyzes and acquires metadata described in said document instance at predetermined timing based on the result of the monitoring in said document operation condition monitoring step.

13. The document information management program according to claim 9, further comprising:
a stored data acquisition step of acquiring metadata from said storage device; and
a metadata writing operation step of writing a prescribed piece of metadata among said metadata acquired in said stored data acquisition step into said document instance.

14. The document information management program according to claim 13, further comprising:
an acquired metadata presentation step of presenting said metadata acquired by said stored data acquisition step to said user;
wherein said metadata writing operation step writes into said document substance those pieces of metadata, among said metadata presented in said acquired metadata presentation step, which are instructed by said user.

15. The document information management program according to claim 9, further comprising:
a new metadata acquisition step of extracting new metadata based on a plurality of pieces of metadata acquired from said storage device or management data managed by an external data management section; and a new metadata writing operation step of writing a prescribed piece of metadata among said metadata acquired in said new metadata acquisition step into said document instance.

16. The document information management program according to claim 15, further comprising:
a new metadata presentation step of presenting said metadata acquired in said new metadata acquisition step to said user;
wherein said new metadata writing operation step writes into said document substance those pieces of metadata, among said metadata presented in said new metadata presentation step, which are instructed by said user.

17. A document information management method for managing metadata described in a document instance thereby to manage document information, said method comprising:
a metadata analysis step of analyzing and acquiring the metadata described in the inside of said document instance;
a storage operation sep of storing a prescribed piece of metadata among said metadata analyzed in said metadata analysis step into a storage device in such a manner as to be able to make it correspond to said document; and
a metadata deletion operation step of deleting said metadata stored in said storage device from the inside of said document instance.

18. The document information management method according to claim 17, further comprising:
a use trend analysis step of analyzing the trend of the use of metadata of said user;
wherein said storage operation step stores a prescribed piece of metadata based on the use trend of said user analyzed in said use trend analysis step into said storage device, and said metadata deletion operation step deletes said prescribed piece of metadata based on the use trend of said user analyzed in said use trend analysis step from the inside of said document instance.

19. The document information management method according to claim 17, further comprising:
a stored data acquisition step of acquiring metadata from said storage device; and
a metadata writing operation step of writing a prescribed piece of metadata among said metadata acquired in said stored data acquisition step into said document instance.

20. The document information management method according to claim 17, further comprising:
a new metadata acquisition step of extracting new metadata from a plurality of pieces of metadata and externally managed data; and
a new metadata writing operation step of writing a prescribed piece of metadata among said metadata acquired in said new metadata acquisition step into said document instance.
